(19) United States
(12) Patent Application Publication
(10) Pub. No.: US 2023/0391151 A1
(43) Pub. Date: Dec. 7, 2023

(54) Hitch Mounted Entertainment Device

(71) Applicants: Aaron McGuin, Mishawaka, IN (US); Clair E. McGuin, Mishawaka, IN (US)

(72) Inventors: Aaron McGuin, Mishawaka, IN (US); Clair E. McGuin, Mishawaka, IN (US)

(21) Appl. No.: 18/205,921

(22) Filed: Jun. 5, 2023

Related U.S. Application Data
(60) Provisional application No. 63/349,489, filed on Jun. 6, 2022.

(51) Int. Cl. B60D 1/62; B60R 11/02

(52) U.S. Cl. CPC B60D 1/62; B60R 11/02

(57) ABSTRACT

An entertainment device that detachably mounts to a vehicle's conventional tow hitch assembly. The hitch mounted entertainment system includes an A/V unit and a hitch mount that allows the NV unit to be readily fitted to the hitch receiver.

This application claims the benefit of U.S. Provisional Patent Application, Ser. No. 63/349,489 filed Jun. 6, 2022, the disclosure of which is hereby incorporated by reference.

This invention relates to vehicle based entertainment system, and in particular, an entertainment device mounted to the vehicle's hitch assembly.

### BACKGROUND AND SUMMARY OF THE INVENTION

Entertainment systems are common component is automobiles and other personal conveyances. Most vehicle based entertainment systems are designed provide entertainment and sound to occupants of the vehicle, even though sound may be directed and emanated from the vehicle interior through open windows and doors.

This invention provides an entertainment device that detachably mounts to a vehicle's conventional tow hitch assembly. The hitch mounted entertainment device includes an A/V unit and a hitch mount that allows the A/V unit to be readily fitted to the hitch receiver. In certain embodiments of the entertainment device, the hitch mount includes its own mount bar extending from the A/V unit that fits into the hitch receiver. In other embodiments, the NV unit can be detachably fitted to a dedicated mount bar or the ball interface of a conventional mount bar. The A/V units has an enclosure that houses a variety of conventional NV components, such as speakers, amplifiers, cross-overs, tuners, antenna, connectors, batteries, transformers and circuit boards. In certain embodiments, the A/V unit may be an independent component from the vehicles conventional entertainment systems, using internal batteries. In other embodiments, the A/V unit may be powered and directly connected to the vehicles entertainment systems via a wired connection of the tow hitch assembly.

The features and advantages of this invention will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is an exploded perspective view of an exemplary embodiment of the hitch mounted entertainment device and a conventional vehicle hitch assembly;

FIG. 2 is a partial perspective view of a vehicle hitch assembly and the hitch mounted entertainment device of FIG. 1;

FIG. 3 is a partial side view of a vehicle hitch assembly and the hitch mounted entertainment device of FIG. 1;

FIG. 4 is a partial rear view of a vehicle hitch assembly and the hitch mounted entertainment device of FIG. 1;

FIG. 5 is an exploded perspective view of a second exemplary embodiment of the hitch mounted entertainment device and a conventional vehicle hitch assembly;

FIG. 6 is a partial side view of a vehicle hitch assembly and the hitch mounted entertainment device of FIG. 5;

FIG. 7 is a partial side view of the hitch mounted entertainment device of FIG. 5 mounted to a vehicle hitch assembly;

FIG. 8 is an exploded perspective view of a second exemplary embodiment of the hitch mounted entertainment device and a conventional vehicle hitch assembly;

FIG. 9 is an exploded side view a vehicle hitch assembly and the hitch mounted entertainment device of FIG. 8; and

FIG. 10 is a partial side sectional view of the hitch mounted entertainment device of FIG. 8 mounted to a vehicle hitch assembly.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

The drawings illustrate multiple exemplary embodiments of the hitch mounted entertainment device of this invention. As shown, each embodiment of this invention is designed to be mounted to a conventional tow hitch assembly 10. As known, tow hitch assemblies 10 typically includes a hitch receiver 20, a mount bar 30 and a wiring harness connector 40. Hitch receiver 20 is a rectangular metal tube mounted to the vehicle frame beneath the rear bumper of the vehicle. Typically, mount bar 30 includes a hitch ball 50 used to couple to a trailer (not shown). Hitch receiver 20 accepts mount bar 30 that is inserted into the receiver and secured by a hitch pin 22 and cotter key 24. It should be noted that other locking hitch pins and fasteners for securing mount bar 30 to receiver 20 are well known in the industry. Typically, wiring harness connector 40 is mounted to the vehicle bumper adjacent hitch receiver 20 and is wired into the vehicle's electrical systems to provide electrical power and signal connectivity to the electrical components of trailers and other towed equipment.

Each embodiment of the hitch mounted entertainment device, includes an A/V unit and a hitch mount that allows the NV unit to be readily connected to a conventional vehicle tow hitch assembly 10. The NV units has an enclosure that houses a variety of conventional A/V components, such as speakers, amplifiers, cross-overs, tuners, antenna, connectors, batteries, transformers and circuit boards. The unit housing is constructed from a suitable material to be water resistant to protect the electrical power supply and electronic circuitry housed inside. In certain embodiments, the A/V unit may be an independent component from the vehicles conventional entertainment systems, using internal batteries. In other embodiments, the A/V unit may be powered and directly connected to the vehicles entertainment systems via a wired connection of the tow hitch assembly 10. The NV units include circuitry to allow interoperability and connection, whether through wired or wireless connections, to smart phones, radios and other entertainment device as desired. In certain embodiments, the NV units may include various auxiliary power outlets, USB ports and device inputs. In other embodiments, the NV units may be connected to video monitors using either wired or wireless connections.

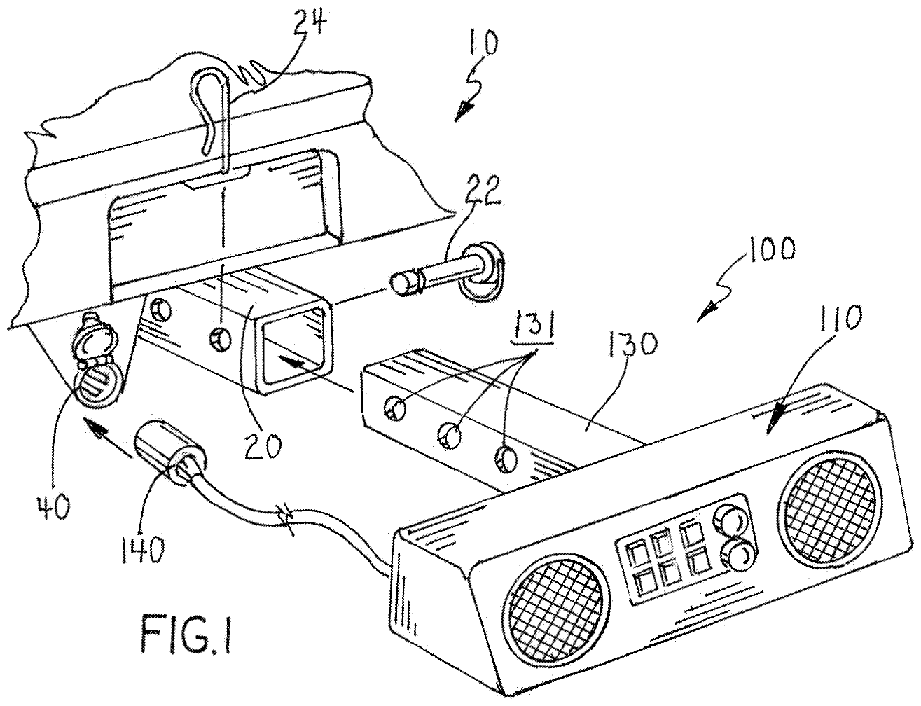

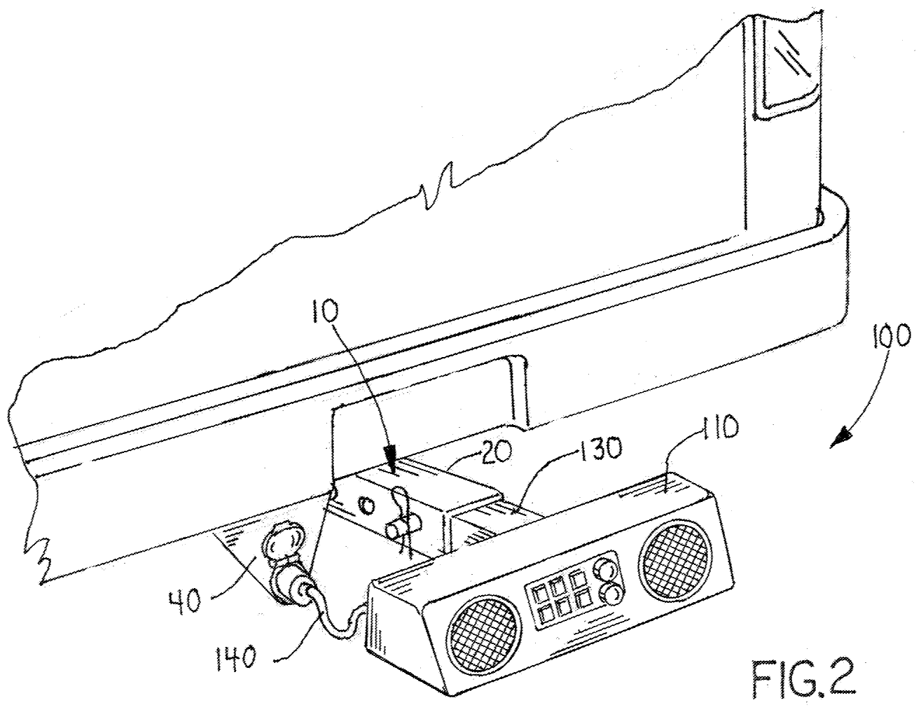

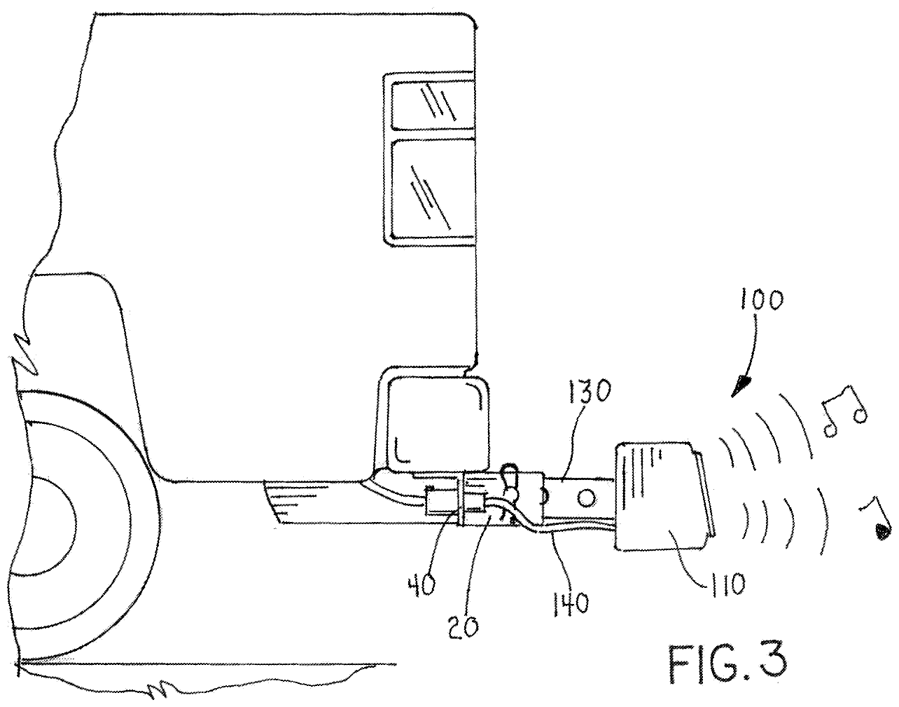

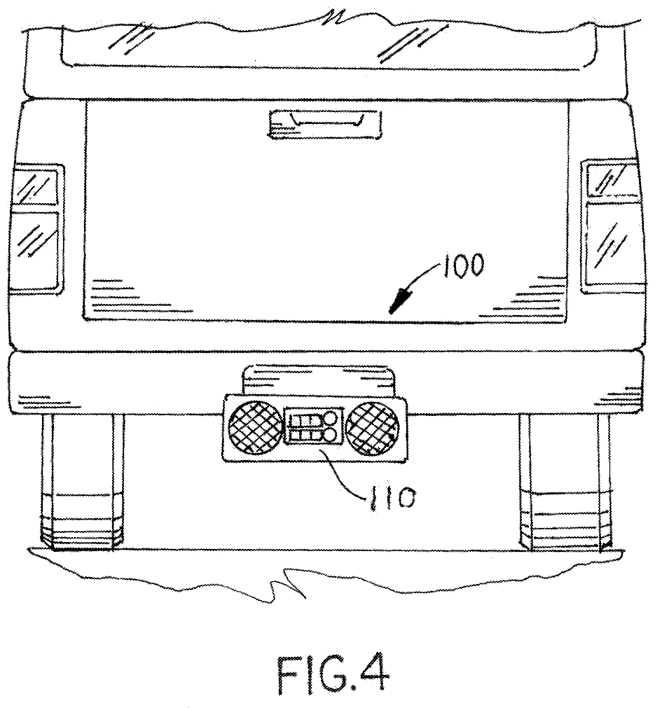

FIGS. 1-4 illustrate an exemplary embodiment of the hitch mounted entertainment device of this invention, which is designated generally as reference numeral 100. Entertainment device 100 includes an A/V unit 110 and a hitch bar 120. NV unit 110 includes a housing 112, a pair of speakers 114 and control panel 116. NV unit 110 includes a wired NV connector 140 that connects to wiring harness connector 40 of the tow hitch assembly 10 to provide electrical power to the unit and/or connect the unit to the vehicles entertainment system (not shown). Hitch bar 130 is a length of rectangular tubing extending from the rear of NV unit 110 and dimensioned to slide into receiver 20. Hitch bar 130 has a plurality of aligned holes 131 along its sides, through which hitch pin 22 extends to secure entertainment device 100 to tow hitch assembly 10. As shown in FIGS. 2 and 3, entertainment device 100 detachably mounts to tow hitch assembly 10 so that the NV unit 110 extends rearward from hitch receiver 20 beneath the bumper and any tailgate or rear doors. Entertainment device 100 can be readily detached from hitch receiver 20 for storage within the vehicle when not used.

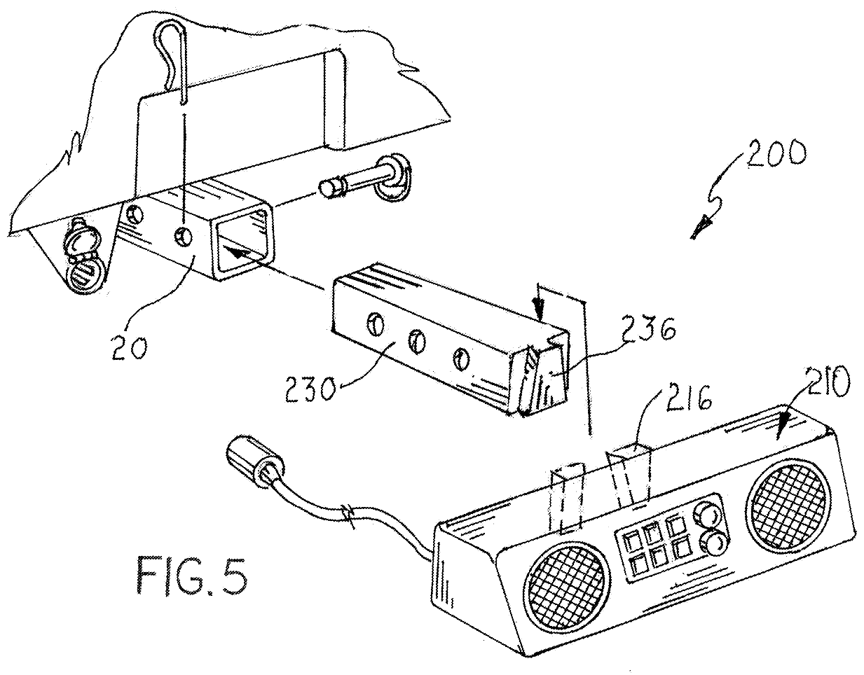

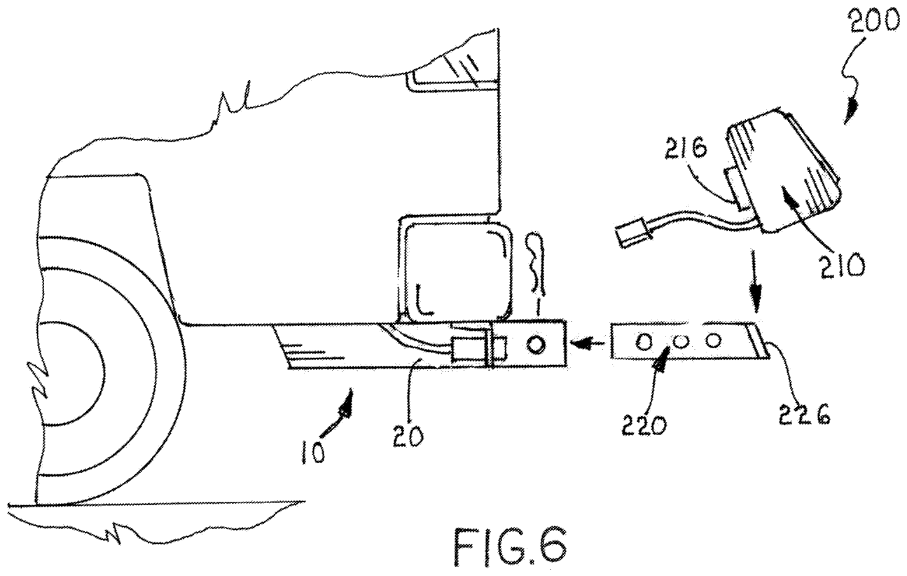

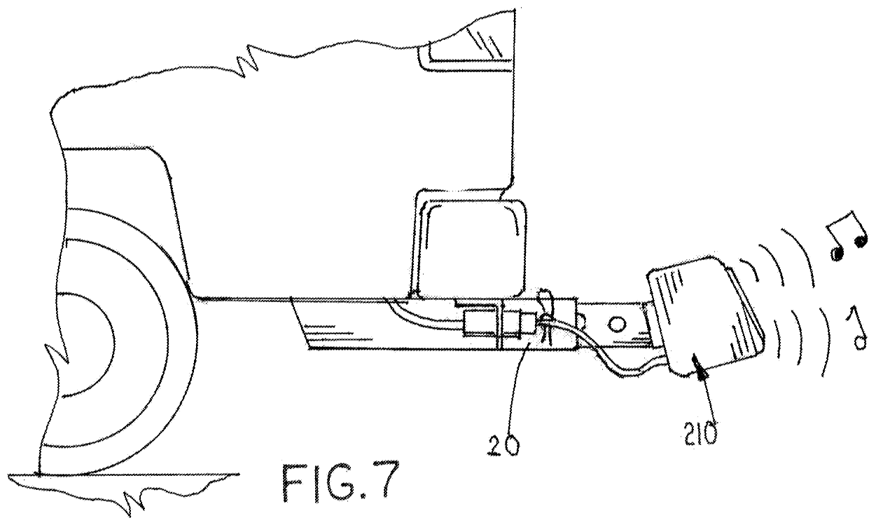

FIGS. 5-7 illustrate a second exemplary embodiment of the hitch mounted entertainment device of this invention, which is designated generally as reference numeral 200. Entertainment device 200 is nearly identical in design and function as entertainment device 100, supra. Entertainment device 200 again includes an NV unit 210 and a hitch bar 230; however, the hitch bar disconnects from the NV unit to provide more compact storage when entertainment device 20 is not in use. As shown, one end of hitch bar 230 terminates in a dove tail protrusion 236. NV unit 210 includes a coupler 216 affixed to the back of NV unit 210. Coupler 216 is configured to received protrusion 236 to detachably connect hitch bar 220 to A/V unit 210. As shown, NV unit 210 connects to hitch bar 220 with coupler 216 sliding onto protrusion 226 and being held in place by gravity. In other embodiments, the interface between coupler 216 and protrusion 226 can be enhanced by locking pins, clasps and other similar mechanisms.

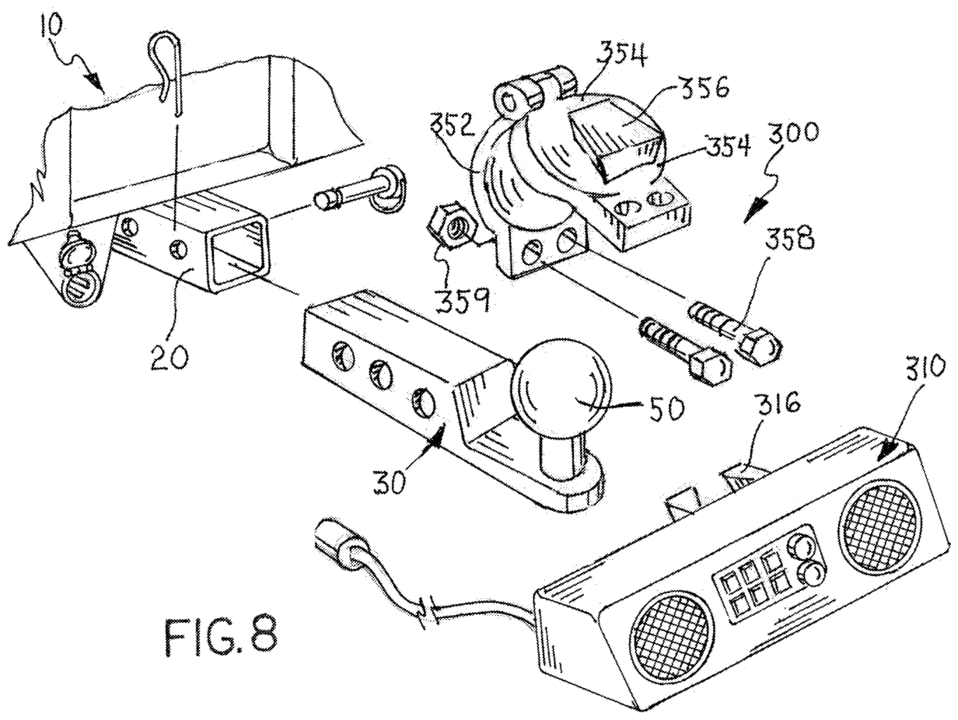

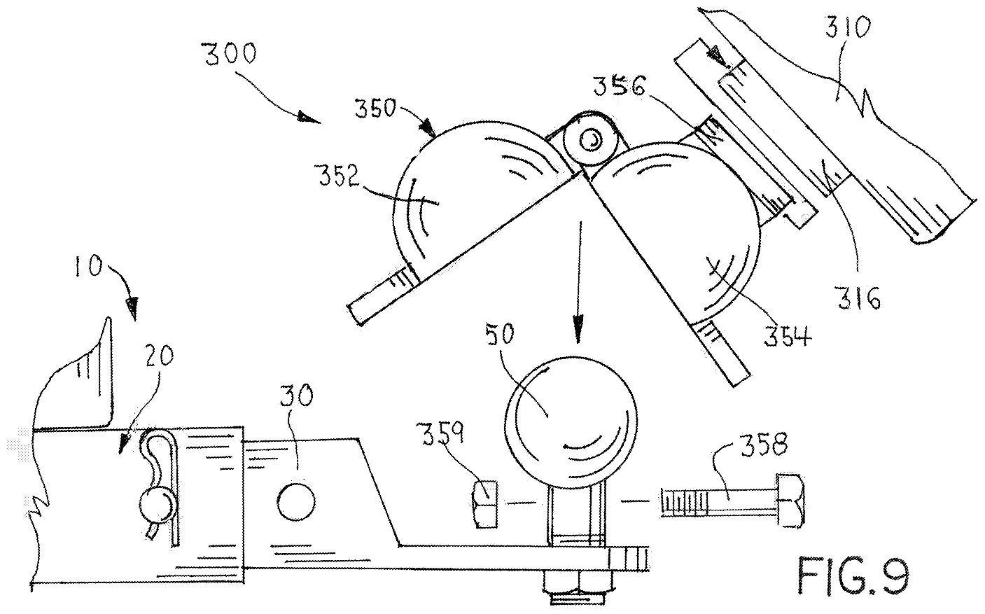

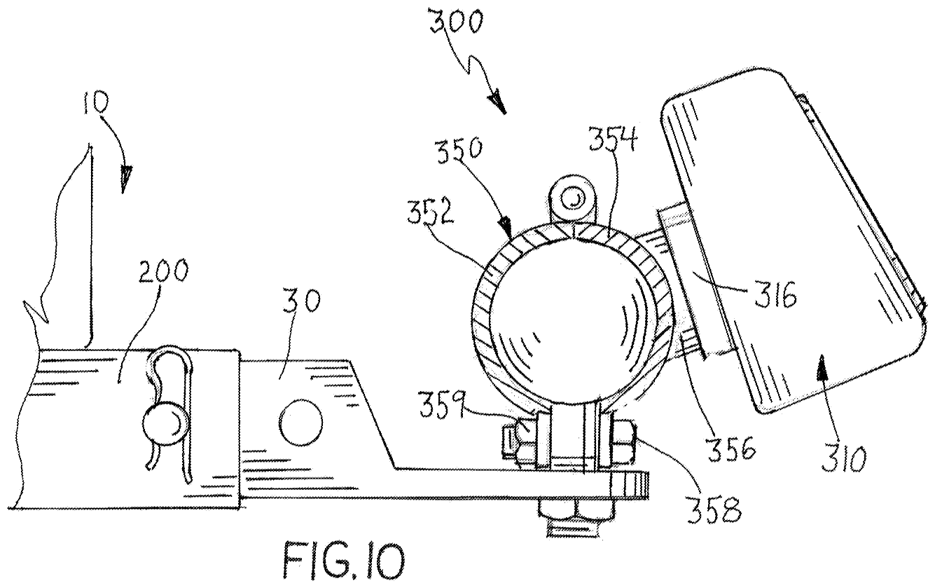

FIGS. 8-10 illustrate a second exemplary embodiment of the hitch mounted entertainment device of this invention, which is designated generally as reference numeral 300. Again, entertainment device 300 is similar in function as Entertainment devices 100 and 200, supra, but is designed and intended to mount directly to hitch ball 50 of a conventional hitch bar 20. Entertainment device 300 includes an A/V unit 310 and a clam-shell ball mount 350. Ball mount 350 has two hinged shell halves 352 and 354 that are dimensioned to clamp around hitch ball 50. Ball mount 350 is clamped in place to hitch ball 50 by a U-shaped threaded fastener and a pair of hex nuts that extend through the shell halves 352 and 354. Shell half 354 has a dove tail protrusion 356. A/V unit 310 includes a coupler 316 affixed to the back of A/V unit 310. Coupler 316 is configured to received protrusion 356 to detachably connect A/V unit 310 to ball mount 350. As shown, A/V unit 310 connects to ball mount 350 with couple 316 sliding onto protrusion 356 and being held in place by gravity.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

We claim:

1. In a vehicle tow hitch assembly including a hitch receiver and an electrical power connector integrally connected to a vehicle electrical system, an entertainment device comprising:
an A/V unit; and
a hitch mount for detachably connecting the A/V unit to the hitch receiver.

2. The entertainment device of claim 1 where the A/V unit includes a wired connector adapted to operatively connect the A/V unit to the vehicle electrical system.

3. The entertainment device of claim 1 wherein the hitch mount includes an elongated bar adapted to seat into the hitch receiver.

4. The entertainment device of claim 3 wherein the bar extends from the NV unit.
